(19) United States
(12) Patent Application Publication
(10) Pub. No.: US 2015/0072261 A1
(43) Pub. Date: Mar. 12, 2015

(54) HIGH POWER HIGH EFFICIENCY FLOW TYPE BATTERY

(71) Applicants: Matthew Mench, Knoxville, TN (US); Thomas Zawodzinski, Knoxville, TN (US); Che-Nan Sun, Knoxville, TN (US)

(72) Inventors: Matthew Mench, Knoxville, TN (US); Thomas Zawodzinski, Knoxville, TN (US); Che-Nan Sun, Knoxville, TN (US)

(21) Appl. No.: 14/075,390

(22) Filed: Nov. 8, 2013

Related U.S. Application Data
(60) Provisional application No. 61/874,480, filed on Sep. 6, 2013.

(51) Int. Cl. H01M 8/18; H01M 8/20

(52) U.S. Cl. CPC H01M 8/188; H01M 8/20
USPC 429/452; 429/499

(57) ABSTRACT

An electrochemical flow type battery may include at least one electrode and a separator. The electrode may include carbon fibers and/or carbon particles, and has an internal surface area density of at least 1 m²/g. The separator may separate an anode side and a cathode side of the battery. A flat surface of the electrode directly contacts a surface of the separator.

### CROSS-REFERENCE TO RELATED APPLICATIONS

This application claims benefit under 35 U.S.C. §119(e) of U.S. Provisional Application Ser. No. 61/874,480, filed Sep. 6, 2013, which is incorporated herein by reference in its entirety.

### STATEMENT REGARDING FEDERALLY SPONSORED RESEARCH OR DEVELOPMENT

This invention was made with government support under a grant from the National Science Foundation, Grant No. EPS-1004083. The U.S. Government has certain rights in this invention.

### BACKGROUND

As technologies advance, there is a world-wide need for large-scale energy storage for a variety of applications. These may include, but are not limited to, electric grid-scale stabilization for integration of renewable power sources such as wind and solar power, greater efficiency of the grid, and reserve support in place of fossil-fuel-based facilities. Several types of batteries have been developed to meet these needs. They may be characterized as non-flow type and flow type batteries. Although non-flow batteries such as Sodium-Sulfur and Lithium Ion have been demonstrated at the megawatt (MW) scale, they have not shown the ability to meet the requirements for cost, safety and lifetime required by grid-scale applications. Batteries with flowing electrolytes (flow type), on the other hand, show promise of meeting the essential requirements of these applications; and a variety of such systems has been developed, including the zinc-bromine, iron-chromium, bromine-polysulfide, and all-vanadium systems. The latter system has been demonstrated in dozens of installations in North America, Africa and particularly in Asia, and is the closest to commercialization. There remains a need to reduce cost of the battery systems while maintaining performance capabilities.

There remains a need in the art, for an electrolyte flow-type battery with greatly increased power density, achieved by reduction of ohmic, kinetic and mass transport polarizations, at high electrical efficiency.

### BRIEF DESCRIPTION OF THE DRAWINGS

FIG. 1A illustrates a cross sectional diagram of an exemplary battery according to an embodiment.

FIG. 1B illustrates details of channels of an exemplary battery according to an embodiment.

FIG. 2 illustrates performance enhancements of an exemplary battery according to an embodiment.

FIG. 3 illustrates performance enhancements of an exemplary battery according to an embodiment.

FIG. 4 illustrates performance enhancements of an exemplary battery according to an embodiment.

FIG. 5 illustrates performance enhancements of an exemplary battery according to an embodiment.

### DETAILED DESCRIPTION

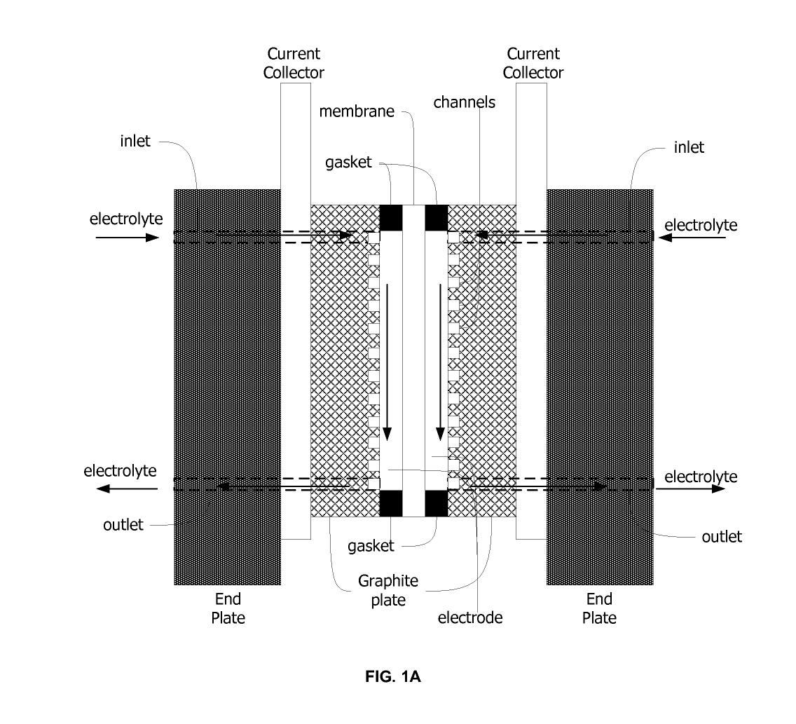

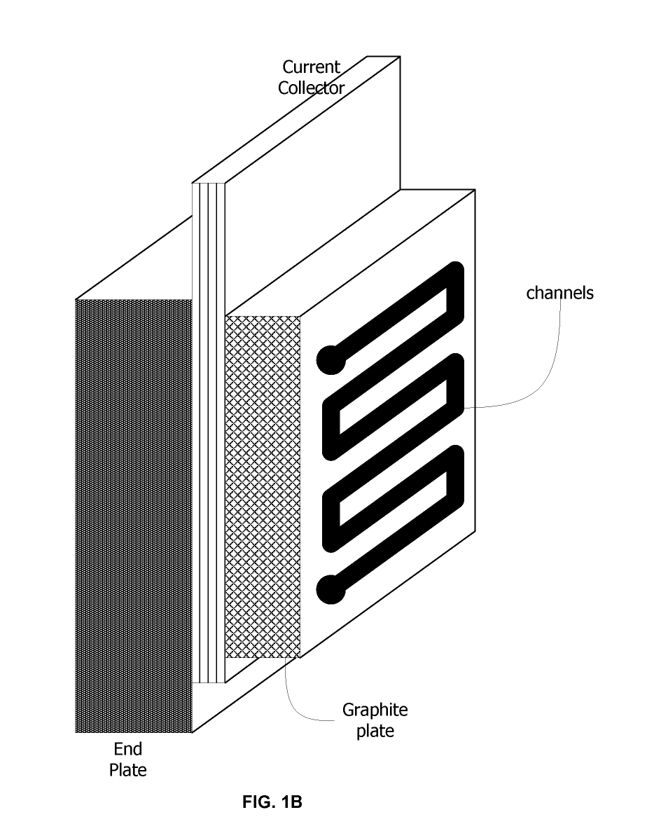

As illustrated in FIGS. 1A and 1B, a battery with flowing aqueous electrolyte may have a structure that includes at least one electrode and a separator. The electrodes, e.g. in the form of carbon paper, may include carbon fibers and/or carbon particles, wherein the electrode material may have an internal specific surface area of at least 1 m²/g. The separator may separate an anode side and a cathode side of the battery. A flat surface of the at least one electrode may directly contact a surface of the separator. The internal specific surface area may represent the amount of microscopic surface area on the carbon fibers and/or carbon particles per unit of weight of the electrodes.

According to an embodiment, the internal specific surface area of the at least one electrode is in the range of 1 m²/g to 500 m²/g.

According to an embodiment, the internal specific surface area of the at least one electrode is at least 10 m²/g.

According to an embodiment, the at least one electrode may be hydrophilic. That is, the carbon fibers and/or carbon particles may be processed to form the electrodes to become hydrophilic and wettable by the electrolyte. According to an embodiment, the at least one electrode comprises a sheet of hydrophilic carbon paper.

According to an embodiment, an other flat surface of the at least one electrode directly contacts a surface of a plate, and at least one channel is formed on the surface of the plate and between the plate and the at least one electrode, such that the aqueous electrolyte flows in parallel and in direct contact with the other flat surface of the at least one electrode.

According to an embodiment, the separator is microporous or nanoporous.

According to an embodiment, at least one of an anolyte electrolyte and a catholyte electrolyte comprises at least one of chloride halide ions and bromide halide ions.

According to an embodiment, an anolyte electrolyte comprises hydrogen ions and a catholyte electrolyte comprises bromide ions.

According to an embodiment, at least one of an anolyte electrolyte and a catholyte electrolyte comprises vanadium.

According to an embodiment, at least one of an anolyte electrolyte and a catholyte electrolyte comprises vanadium based salt dissolved in an aqueous sulfuric acid solution.

According to an embodiment, the separator is an ion-exchange membrane.

According to an embodiment, the separator is an anion-exchange membrane.

According to an embodiment, the separator is a cation-exchange membrane.

According to an embodiment, the separator may include a support network, e.g. a mesh, embedded inside or on at least one surface, to provide mechanical support. Alternatively, the support network may be absent in the separator.

According to an embodiment, at least one gasket may affix the at least one electrode against the separator and a conductive plate.

According to an embodiment, the battery comprises at least one cathode and at least one anode.

Causes of inefficiencies in battery systems may be identified as generally include ohmic, kinetic, crossover, and mass transport losses in electrochemical power systems.

To address above possible losses of efficiencies, a battery system based upon aqueous electrolytic fluid (such as vanadium salts dissolved in an aqueous sulfuric acid solution) was developed. One embodiment of this system exhibits ‘round-trip’ efficiency in a charge-discharge cycle of 80% (high efficiency) when cycled at 500 mA/cm² (high power) between 20% and 80% state of charge. Such a system may include some or all of the following features:

(1) Reduction in mass transport losses through changes in electrolyte flow-field architecture.

(2) Reduction in ohmic losses through decreased thickness of electrode.

(3) Reduction in kinetic losses through optimization of the electrode material and morphology.

(4) Reduction in ohmic losses through optimized membrane selection.

(5) Reduction in kinetic losses though optimization of pre-treatment procedure that simultaneously increases wettability of the electrode and surface area.

(6) Selection, engineering, and assembly of optimized compression and assembly design.

In an embodiment, a battery cell architecture may be employed in which the gap between the electrodes and the separator may be eliminated, placing the electrodes in direct contact with the two opposite surfaces of the separator membrane to form a sandwich with the separator between two electrode sheets. This “zero-gap” design dramatically reduces resistance compared to a “flow-by” electrode design that allows electrolytic fluid to flow between an electrode and the separator membrane, which dramatically increases ohmic loses.

According to an embodiment, a flow channel with various flow path patterns (such as a serpentine pattern) may be used to deliver electrolyte to an electrode adjacent to the flow channel, with the electrode itself being adjacent to the separator. This design may decrease the distance for charge transport compared to a flow-by design and thus decrease ohmic losses, and thus may enhance performance.

As illustrated in FIGS. 1A and 1B, electrolyte may be supplied through inlets, into the channels, and then exit the outlets. The inlets and outlets may pass through various layers in the battery such as end plates, current collectors and graphite plates, in order to allow the electrolyte to flow through the channels and to flow on a surface of the electrode parallel to the electrode surface. As shown in FIG. 1B, the channels may form a serpentine flow path pattern, like an S-shape on a surface of the graphite plate that abuts a surface of the electrode. However, other flow path patterns may be possible, and need not be restricted to a single channel lengthwise and may be several parallel channel paths.

The graphite plates may be used as a substrate to form the channels, and may provide electrical conductive path between the electrodes and respective current collector plates, so that electrical currents generated may flow from the electrodes to respective current collector plates. The design here in FIGS. 1A and 1B is provided with graphite plates, but other material may be used for instead of graphite. End plates may be used to hold the entire cell layer assembly together. Other components and layers may be used, for example, for insulation and electrical connections, etc. Multiple cells may be assembled into a cell stack of N cells with a terminal voltage of N times the single-cell voltage.

In an embodiment of the present invention, kinetic losses may be reduced by adopting an electrode material with higher internal surface area per unit geometric area (for example, 50 times higher) than carbon felt materials in flow type battery electrodes. This enables the use of a substantially thinner electrode. The resulting decrease in ionic resistance within the electrode significantly reduces cell overvoltage and enables significantly greater current density at a given cell voltage.

An all-vanadium based redox flow battery (VRFB) may use vanadium oxysulfate as its positive-electrode electrolyte solution and vanadium sulfate as its negative-electrode electrolyte solution. For the electrode, a high kinetic loss at low current may occur in the all-vanadium redox flow battery (VRFB) that uses carbon felt electrodes which have generally large thickness (˜3 mm). Such electrodes may have significant kinetic limitations related to surface activity and morphology. The relatively low internal surface area of the felt electrode leads to significant kinetic loss as the electrochemical reaction takes place. The relatively thick electrode also results in significant ohmic losses, as the thickness presents a resistive path for current to pass through. Carbon felt electrodes may also exhibit significantly higher contact resistance in the cell than the electrode materials used in this embodiment. In the following description, the performance of these electrodes in an all-vanadium cell is used to illustrate the advantages of a cell structure according to certain embodiments of the present invention.

The kinetic performance, in this case, may be improved by stacking multiple layers of a thinner carbon paper electrode with higher active surface area to decrease the kinetic loss. Such carbon paper material may be composed of carbon fibers and carbon particles, processed and formed into paper-like sheets. The carbon paper sheets may also have additional stiffness compared to carbon felt, to allow for easier manufacturing and mass production of the battery. However, the ionic resistance in a multilayer electrode cell increases proportionally relatively to number of layers and thickness due to a lengthened conduction pathway. Thus, use of a carbon paper electrode with reduced thickness compared to carbon felt electrode with enhanced electrochemically reactive surface area may be a key to enhanced battery performance.

Furthermore, the optimal thickness of the carbon paper electrode not only depends on the surface area of the electrode, but may also depend on the performance of the membrane separator and the processing of the electrode itself to enhance reactive surface area. The kinetic loss can be significantly reduced by using, for example, a carbon electrode material with approximately 25 m²/g (approximately 50 times the internal surface area density of carbon felt material). In addition, thermal and oxidative treatment of the electrodes, may further enhance the ability of the carbon paper electrode to absorb liquid electrolyte. With sufficiently high internal surface area density, the carbon paper electrode thickness may be significantly reduced and therefore decrease the ionic resistance within the electrode.

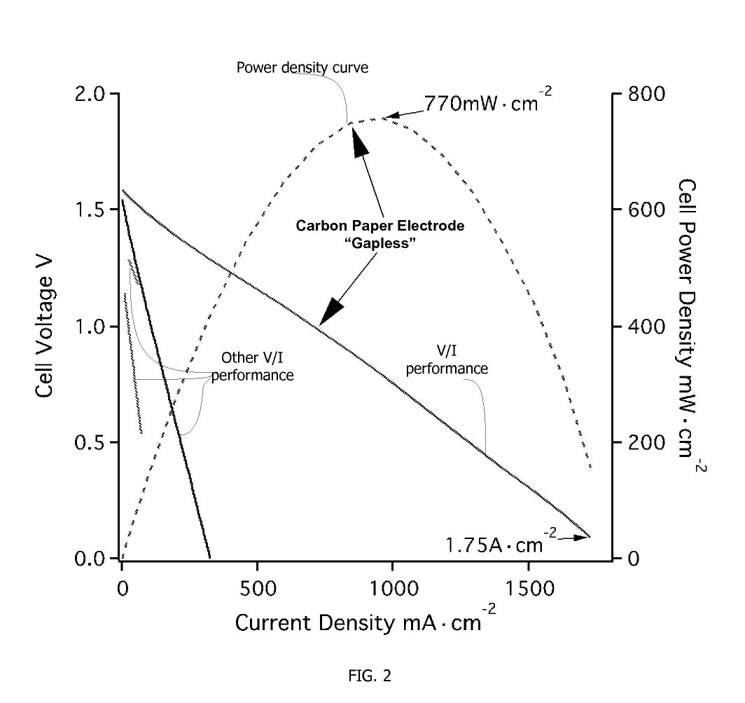

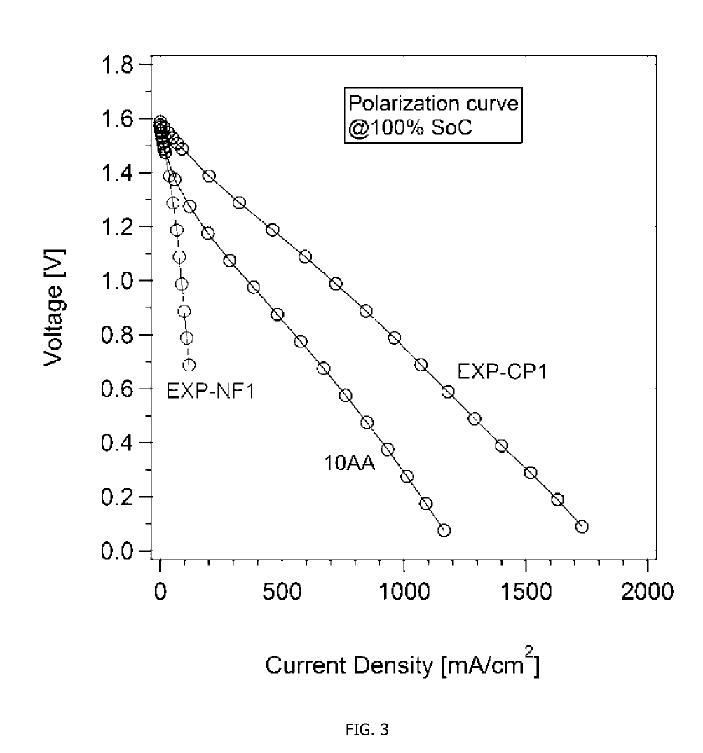

FIGS. 2 and 3 illustrate exemplary test cases of performance enhancements obtained by using the “zero-gap” design of FIG. 1 along with carbon paper electrodes. The higher current density at a given voltage represents a substantial gain in performance. FIG. 2 for example illustrates that the carbon paper electrode with “zero-gap” design may produce much higher current density than other previous designs, and may produce high power density with high efficiency. FIG. 3 for example illustrates that the carbon paper electrode with “zero-gap” design (labeled “EXP-CP1”) may produce much higher current density at the given operating voltage as compared to other battery designs (labeled “EXP-NF1” and “10AA”), at 100% state of charge (SoC).

In an embodiment, thin separator membranes with perfluorocarbon or hydrocarbon polymeric ion exchange materials may be used in a battery cell design. In an exemplary battery design, these thin membranes may yield area-specific resistance (ASR) lower than that for typical ion-exchange membranes to yield increased power density for the battery cell. Polymers such as Nafion™ (a perfluorosulfonate ionomer) and sulfonated Diels-Alder Poly(phenylene) (SDAPP) can exhibit low ASR in the cell when prepared in a sufficiently thin membrane.

The membrane separator is also improved upon in our high-performance design. Nafion™ is an ion-selective membrane which is used in the fuel cell industry owing to its relatively high conductivity, availability, and durability in oxidative and reducing environments. In previous work, the thinnest commercially available perfluorosulfonic acid based membrane Nafion™ (Nafion 211) does not yield very high performance due to severe crossover of the vanadium species.

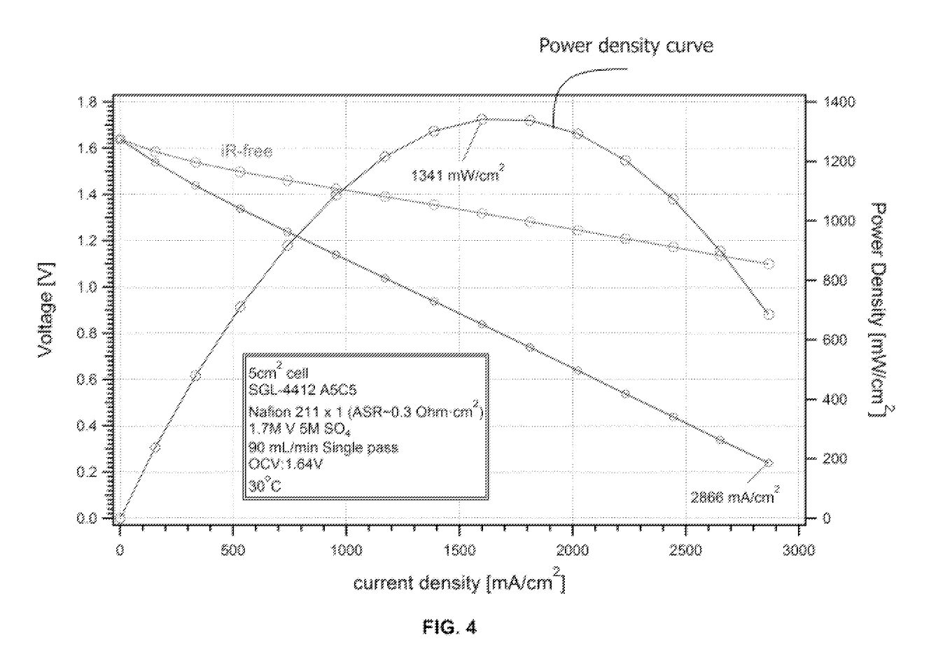

However, the high internal surface area density electrode (such as carbon paper electrode) with the “zero-gap” design may mitigate the crossover issue and lower the area specific resistance (ASR) to <0.3 ohm·cm². In addition, instead of Nafion™, thin hydrocarbon membranes may have comparable or even lower ASR and reduce the impact of the vanadium crossover issue. Thus, thin hydrocarbon type membranes may be used instead of Nafion™ to result in even higher performance in a battery system. FIG. 4 illustrates exemplary test cases of the combined effects of hydrocarbon membrane vs. Nafion™ membrane with the carbon paper electrode and “zero-gap” design.

In an exemplary battery, single pass electrolyte flow, i.e. with no solution recirculation, with high vanadium concentration at ˜100% state-of-charge may decrease the mass transport loss by maintaining a high reactant concentration at the inlets. Furthermore, increasing the electrolyte flow rate, for example as driven by an electrolyte pump, may induce some convection flow of the electrolyte and may facilitate the diffusion of the electrolyte within the electrode, i.e. to increase reactant electrolyte flow from a cathode side to an anode side or vice versa.

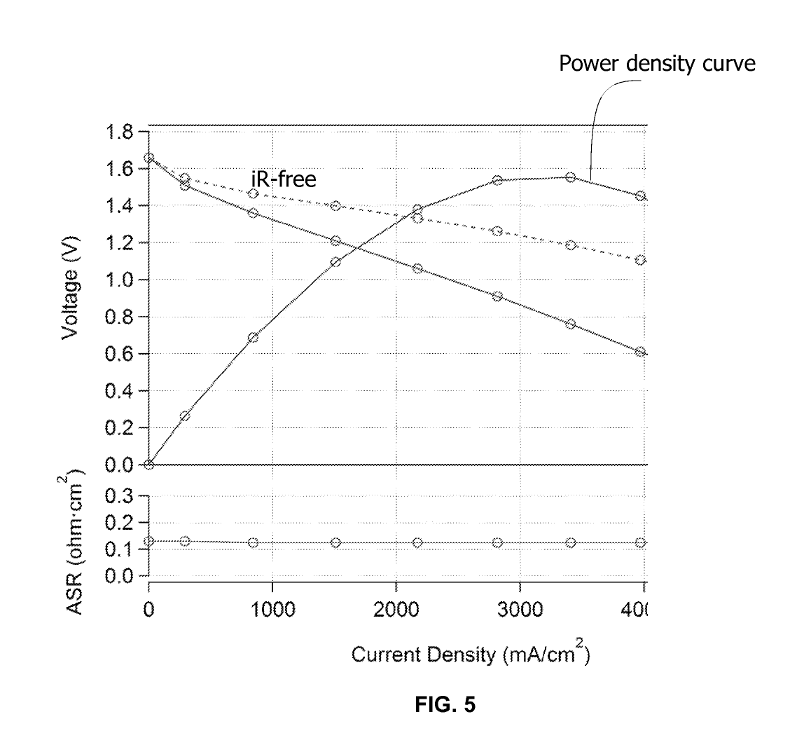

The higher internal surface area density electrode (such as the carbon paper electrode) may also absorb electrolyte solution much faster or more completely to facilitate the mass transport and may lead to better battery performance. FIG. 5 illustrates exemplary test cases of the combined effects of the additional mass transport enhancements above, with two voltage vs. current curves and a power density curve.

Substantial performance gains may be realized in Vanadium Redox Flow Batteries with the above embodied features.

It is appreciated that the disclosure is not limited to the described embodiments, and that any number of scenarios and embodiments may be possible.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A battery with flowing aqueous electrolyte, comprising:
at least one electrode comprising carbon fibers or carbon particles, wherein the electrode has an internal surface area density of at least 1 m²/g; and
a separator separating an anode side and a cathode side of the battery,
wherein a flat surface of the at least one electrode directly contacts a surface of the separator.

2. The battery of claim 1, wherein the internal surface area density of the at least one electrode is in the range of 1 m²/g to 500 m²/g.

3. The battery of claim 1, wherein the internal surface area density of the at least one electrode is at least 10 m²/g.

4. The battery of claim 1, wherein the at least one electrode is hydrophilic.

5. The battery of claim 1, wherein the at least one electrode is wettable by the flowing aqueous electrolyte.

6. The battery of claim 1, wherein the at least one electrode comprises a sheet of hydrophilic carbon paper.

7. The battery of claim 1, wherein an other flat surface of the at least one electrode directly contacts a surface of a plate, and at least one channel is formed on the surface of the plate and between the plate and the at least one electrode, such that the aqueous electrolyte flows in parallel and in direct contact with the other flat surface of the at least one electrode.

8. The battery of claim 1, wherein the separator is microporous or nanoporous.

9. The battery of claim 1, wherein at least one of an anolyte electrolyte and a catholyte electrolyte comprises at least one of chloride halide ions and bromide halide ions.

10. The battery of claim 1, wherein an anolyte electrolyte comprises hydrogen ion and a catholyte electrolyte comprises bromide ions.

11. The battery of claim 1, wherein at least one of an anolyte electrolyte and a catholyte electrolyte comprises vanadium.

12. The battery of claim 1, wherein the separator is an ion-exchange membrane.

13. The battery of claim 12, wherein the separator is an ion-exchange membrane comprising a hydrocarbon polymeric material.

14. The battery of claim 12, wherein the separator is an anion-exchange membrane.

15. The battery of claim 12, wherein the separator is a cation-exchange membrane.

16. The battery of claim 1, further comprising at least one gasket affixing the at least one electrode against the separator and a conductive plate.

17. The battery of claim 1, wherein the battery comprises at least one cathode and at least one anode.

18. A battery with flowing aqueous electrolyte, comprising:
at least one electrode comprising carbon fibers and carbon particles, wherein the electrode has an internal surface area density of at least 1 m²/g; and
a separator separating an anode side and a cathode side of the battery,
wherein a flat surface of the at least one electrode directly contacts a surface of the separator.

19. A battery with flowing aqueous electrolyte, comprising:
a stack of a plurality of cells,
each of the plurality of cells comprises:
at least one electrode comprising carbon fibers or carbon particles, wherein the electrode has an internal surface area density of at least 1 m²/g; and
a separator separating an anode side and a cathode side of each cell,
wherein a flat surface of the at least one electrode directly contacts a surface of the separator.
